(19) United States
(12) Patent Application Publication
(10) Pub. No.: US 2025/0147566 A1
(43) Pub. Date: May 8, 2025

(54) SEMICONDUCTOR SYSTEM FOR REDUCING OPERATING TIME AND OPERATING METHOD THEREOF

(71) Applicant: SAMSUNG ELECTRONICS CO., LTD., SUWON-SI (KR)

(72) Inventors: Yooseok SON, Suwon-si (KR); Sehun KIM, Suwon-si (KR); Heeseong LEE, Suwon-si (KR)

(21) Appl. No.: 18/915,876

(22) Filed: Oct. 15, 2024

(30) Foreign Application Priority Data
Nov. 7, 2023 (KR) 10-2023-0153097

(51) Int. Cl. G06F 1/3206

(52) U.S. Cl. CPC G06F 1/3206

(57) ABSTRACT

A semiconductor system including: a memory to store data; a first master intellectual property (IP) block configured to generate a first wakeup signal; a first bus block configured to generate a second wakeup signal while performing a wakeup operation in response to the first wakeup signal; a second bus block configured to generate a third wakeup signal while performing the wakeup operation in response to the second wakeup signal; and a third bus block configured to perform data communication with the memory and perform the wakeup operation in response to the third wakeup signal.

### CROSS-REFERENCE TO RELATED APPLICATION

This application claims priority under 35 U.S.C. § 119 to Korean Patent Application No. 10-2023-0153097, filed on Nov. 7, 2023, in the Korean Intellectual Property Office, the disclosure of which is incorporated by reference herein in its entirety.

### TECHNICAL FIELD

The inventive concept relates to a semiconductor system and an operating method thereof, and, more particularly to, a semiconductor system for reducing an operating time and an operating method thereof.

### DISCUSSION OF RELATED ART

A semiconductor system may include one or more blocks, where each block may include one or more intellectual property (IP) blocks, a clock management unit (CMU), and a power management unit (PMU). To reduce the idle power consumption of a block, the system can perform a power off operation for an IP block, which typically involves stopping the delivery of a clock signal from a CMU to the IP block when it is not in use.

When the power off operation is performed, and a power on operation is performed for a specific IP block currently in a power off state, if other blocks are interconnected via a hierarchical bus, the power on operation needs to be conducted in sequence across the related blocks. Accordingly, the time required to perform the power on operation may increase with the number of correlated blocks, potentially impairing the performance of the semiconductor system. Therefore, there is a need for technology that can reduce the time required to perform the power on operation.

### SUMMARY

The inventive concept provides a semiconductor system for reducing the time for a power on operation, and an operating method thereof.

According to an embodiment of the inventive concept, there is provided a semiconductor system including: a memory to store data; a first master intellectual property (IP) block configured to generate a first wakeup signal; a first bus block configured to generate a second wakeup signal while performing a wakeup operation in response to the first wakeup signal; a second bus block configured to generate a third wakeup signal while performing the wakeup operation in response to the second wakeup signal; and a third bus block configured to perform data communication with the memory and perform the wakeup operation in response to the third wakeup signal.

According to an embodiment of the inventive concept, there is provided a semiconductor system including: a memory to store data; a first level bus block configured to perform data communication with the memory; a second level bus block configured to perform data communication with the first level bus block; and a third level bus block configured to perform data communication with the second level bus block, wherein the first level bus block and the second level bus block are configured to perform a wakeup operation when the wakeup operation on the third level bus block is performed.

According to an embodiment of the inventive concept, there is provided an operating method of a semiconductor system including bus blocks and a plurality of intellectual property (IP) blocks, the operating method including: transmitting a first wakeup signal to a second bus block that performs data communication with a first bus block among the bus blocks, while performing a wakeup operation on the first bus block; transmitting a second wakeup signal to a third bus block that performs data communication with the second bus block, while performing the wakeup operation on the second bus block in response to the first wakeup signal; and performing the wakeup operation on the third bus block in response to the second wakeup signal, wherein the second bus block is a bus block of a higher level than the first bus block, and the third bus block is a bus block of a higher level than the second bus block.

### BRIEF DESCRIPTION OF THE DRAWINGS

Embodiments of the inventive concept will be more clearly understood from the following detailed description taken in conjunction with the accompanying drawings in which:

FIG. 1 is a block diagram illustrating a semiconductor system according to an embodiment;

FIG. 2 is a flowchart illustrating an operating method of a semiconductor system according to an embodiment;

FIG. 3 is a graph illustrating an operating method of a semiconductor system according to an embodiment;

FIG. 4 is a block diagram illustrating a semiconductor system according to an embodiment;

FIG. 5 is a block diagram illustrating a semiconductor system according to an embodiment;

FIG. 6 is a graph illustrating an operating method of a semiconductor system according to an embodiment;

FIG. 7 is a block diagram illustrating a semiconductor system according to an embodiment;

FIG. 8 is a block diagram illustrating an address decoder of a semiconductor system according to an embodiment;

FIG. 9 is a graph illustrating an operating method of a semiconductor system according to an embodiment;

FIG. 10 is a block diagram illustrating a semiconductor system according to an embodiment;

FIG. 11 is a block diagram illustrating an electronic device according to an embodiment; and

FIG. 12 is a block diagram illustrating an electronic device according to an embodiment.

### DETAILED DESCRIPTION OF THE EMBODIMENTS

Hereinafter, embodiments of the inventive concept will be described in detail with reference to the attached drawings.

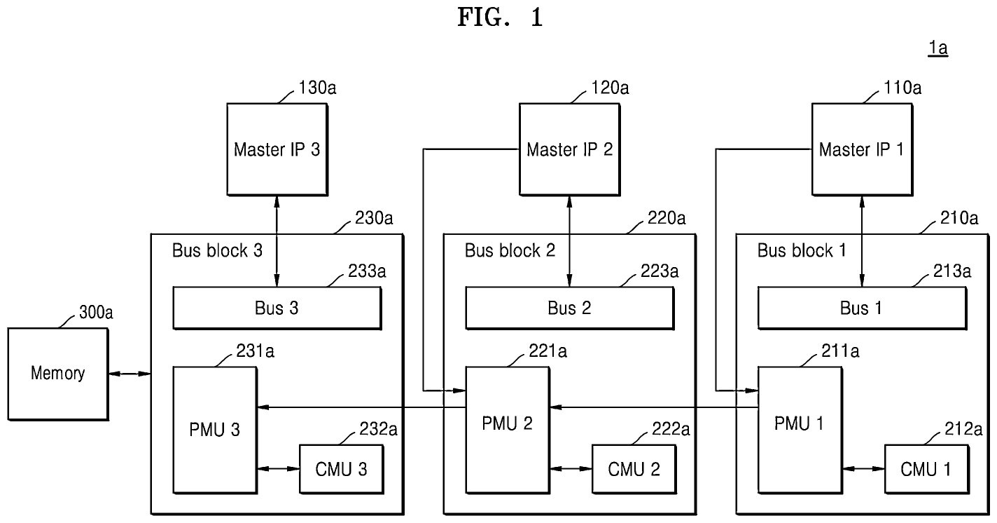

FIG. 1 is a block diagram illustrating a semiconductor system la according to an embodiment.

Referring to FIG. 1, the semiconductor system la may be implemented as a personal computer (PC) or a mobile device. For example, the mobile device may be implemented as a laptop computer, a mobile phone, a smart phone, a tablet PC, a personal digital assistant (PDA), an enterprise digital assistant (EDA), a digital still camera, a digital video camera, a portable multimedia player (PMP), a personal navigation device or a portable navigation device (PND), a handheld game console, a mobile internet device (MID), a wearable computer, an Internet of things (IoT) device, an Internet of everything (IoE) device, a drone, or an e-book, but is not limited thereto.

The semiconductor system 1a may refer to a semiconductor device, and the semiconductor system 1a may be implemented as an integrated circuit (IC), a motherboard, a system on chip (SoC), a microprocessor, an application processor (AP), a mobile AP, a chipset, or a set of semiconductor chips, but is not limited thereto.

The semiconductor system 1a may include first, second and third master intellectual property (IP) blocks 110a, 120a, and 130a, first, second and third bus blocks 210a, 220a, and 230a, and a memory 300a. Although it is shown that the semiconductor system 1a includes the first to third master IP blocks 110a, 120a, and 130a, and the first to third bus blocks 210a, 220a, and 230a, the semiconductor system 1a may include more master IP blocks and bus blocks.

The first to third master IP blocks 110a, 120a, and 130a are function blocks that perform specific functions, and, may each include, for example, a central processing unit (CPU), a graphics processing unit (GPU), a neural network processor (NPU), a communication processor (CP), a digital signal processor (DSP), a video module (e.g., a camera interface, a Joint Photographic Experts Group (JPEG) processor, a video processor, or mixer, etc.), a three-dimensional graphics core, an audio system, or a driver. At least one of the first to third master IP blocks 110a, 120a, and 130a may include at least one core that executes instructions, but the inventive concept is not limited thereto.

The first to third bus blocks 210a, 220a, and 230a may have different levels (or hierarchies). For example, the first bus block 210a may be a third level bus block, the second bus block 220a may be a second level bus block, and the third bus block 230a may be a first level bus block. The lower the level, the higher the level may be referred to, and the higher the bus block, the higher the accessibility to the memory 300a. In other words, the structure implies that blocks at lower levels can reference those at higher levels, and the higher a bus block is positioned, the greater its access to memory becomes.

First, second and third power management units (PMUs) 211a, 221a, and 231a may control or supply power voltages supplied to specific blocks (e.g., the first to third bus blocks 210a, 220a, and 230a).

First, second and third clock management units (CMUs) 212a, 222a, and 232a may control or supply clock signals supplied to specific blocks (e.g., the first to third bus blocks 210a, 220a, and 230a), and transmit and receive control signals to and from the first to third PMUs 211a, 221a, and 231a to perform a clock gating operation on each of the specific blocks (e.g., the first to third bus blocks 210a, 220a, and 230a). The clock gating operation may be an operation of reducing power consumption (e.g., switching power consumption) of a specific block by not supplying a clock signal to the block when an operation of the block is not required. In other words, the clock gating operation involves reducing the power consumption, such as switching power, of a specific block by withholding the clock signal from the block when its operation is not needed.

First, second and third buses 213a, 223a, and 233a may perform data communication between blocks respectively including the first to third buses 213a, 223a, and 233a and other blocks. For example, the first bus 213a may perform data communication with the first master IP block 110a, the second bus 223a may perform data communication with the second master IP block 120a, and, the third bus 233a may perform data communication with the third master IP block 130a. The first to third buses 213a, 223a, and 233a may each be implemented as an advanced microcontroller bus architecture (AMBA), an advanced high-performance bus (AHB), an advanced peripheral bus (APB), an advanced extensible interface (AXI), an advanced system bus (ASB), an AXI coherency extensions (ACE), or a combination thereof, but are not limited thereto.

The first bus block 210a may include the first PMU 211a, the first CMU 212a, and the first bus 213a. The second bus block 220a may include the second PMU 221a, the second CMU 222a, and the second bus 223a. The third bus block 230a may include the third PMU 231a, the third CMU 232a, and the third bus 233a.

The first PMU 211a may receive a wakeup signal from the first master IP block 110a, and transmit the wakeup signal to the second PMU 221a while performing a wakeup operation on the first bus block 210a in response to the received wakeup signal. The wakeup operation refers to initiating a power on operation for a specific block that is currently in a power off state. The power off state refers to a state of a specific block to which a power gating operation has been applied to blocks its power voltage. The power on operation involves applying the blocked power voltage to a block that is in the power off state. The power on state refers to a state of a specific block after the power on operation has been performed on it.

In some embodiments, the first master IP block 110a may generate a first wakeup signal to access the memory 300a, and the first PMU 211a may perform the wakeup operation on the first bus block 210a in response to the first wakeup signal. The first PMU 211a may transmit a second wakeup signal to the second PMU 221a while performing the wakeup operation on the first bus block 210a.

The second PMU 221a may receive the wakeup signal from the first PMU 211a, and transmit the wakeup signal to the third PUM 231a while performing the wakeup operation on the second bus block 220a in response to the received wakeup signal. In some embodiments, the second PMU 221a may perform the wakeup operation on the second bus block 220a in response to the second wakeup signal. The second PMU 221a may transmit a third wakeup signal to the third PMU 231a while performing the wakeup operation on the second bus block 220a.

The third PMU 231a may receive a wakeup signal from the second PMU 221a and perform the wakeup operation on the third bus block 230a in response to the received wakeup signal. In some embodiments, the third PMU 231a may perform the wakeup operation on the third bus block 230a in response to the third wakeup signal.

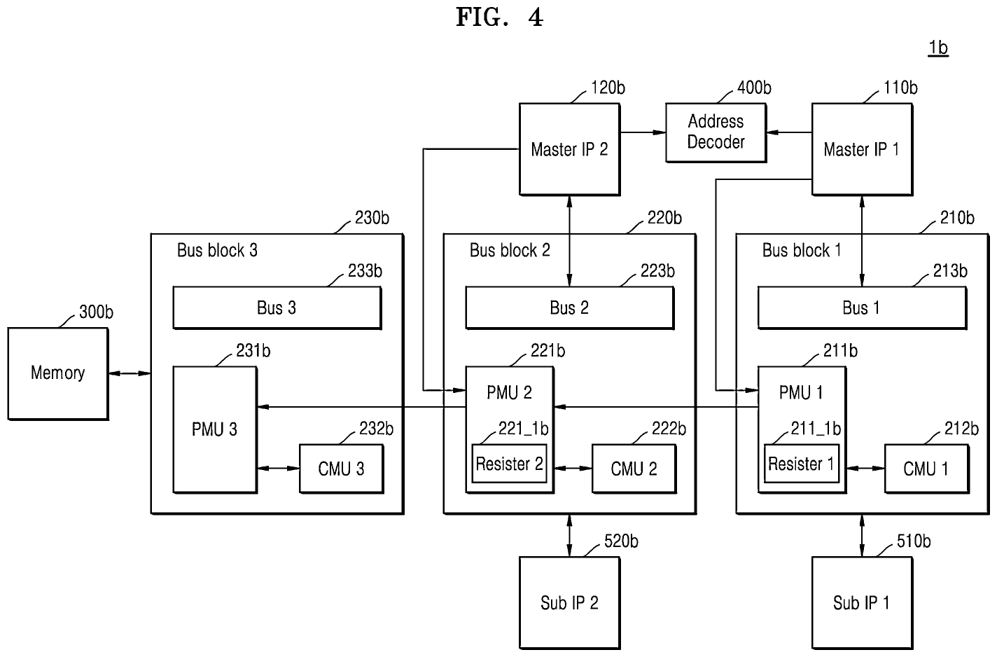

In some embodiments, the first PMU 211a may further include a hierarchical register that masks the wakeup signal transmitted to the second PMU 221a, and the second PMU 221a may further include a hierarchical register that masks the wakeup signal transmitted to the third PMU 231a. An embodiment related to the hierarchical register is described below with reference to FIGS. 4 to 6.

The third level bus block or the second level bus block may further include a hierarchical register that masks the wakeup signal transmitted to a higher level bus block. An embodiment related to the hierarchical register is described below with reference to FIGS. 4 to 6.

The memory 300a is a storage location for storing data, and may be electrically connected to the third bus block 230a. In this specification, the memory 300a is described as Dynamic Random Access Memory (DRAM) but is not limited thereto. For example, the memory 300a may include volatile memory such as Static RAM (SRAM), or non-volatile memory such as Phase Change RAM (PRAM), Resistive RAM (ReRAM), and Magnetic RAM (MRAM) flash memory.

In comparative examples, when a master IP block performing data communication with a lower level bus block accesses a memory performing data communication with a higher level bus block, the master IP block may sequentially perform the wakeup operation on blocks from the lower level bus block to the higher level bus block. For example, after completing the wakeup operation on the third level bus block, the master IP block may transmit the wakeup signal to the second level bus block, and after completing the wakeup operation on the second level bus block in response to the wakeup signal received by the second level bus block, transmit the wakeup signal to the first level bus block. A wakeup operation time may increase in proportion to the number of blocks from the lower level bus block to the higher level bus block. In other words, the time required for a wakeup operation may increase proportionally with the number of blocks from a lower-level bus block to a higher-level bus block. For example, assuming that the number of blocks from the lower level bus block to the higher level bus block is 3 and the wakeup operation time for one bus block is t, the wakeup operation time may be 3*t.

On the other hand, according to the semiconductor system 1a of the inventive concept, when the first master IP block 110a accesses the memory 300a, the first master IP block 110a may transmit the wakeup signal to the second bus block 220a while performing the wakeup operation on the first bus block 210a, and transmit the wakeup signal to the third bus block 230a while performing the wakeup operation on the second bus block 220a. Accordingly, the wakeup operation time for the first bus block 210a, the second bus block 220a, and the third bus block 230a may be less than 3*t. Therefore, the semiconductor system 1a of the inventive concept may perform the power on operation on each of a plurality of blocks together, and reduce the time required to perform the power on operation, thereby enhancing the performance of the semiconductor system 1a. For example, the semiconductor system 1a is capable of executing the power-on operation simultaneously across multiple blocks.

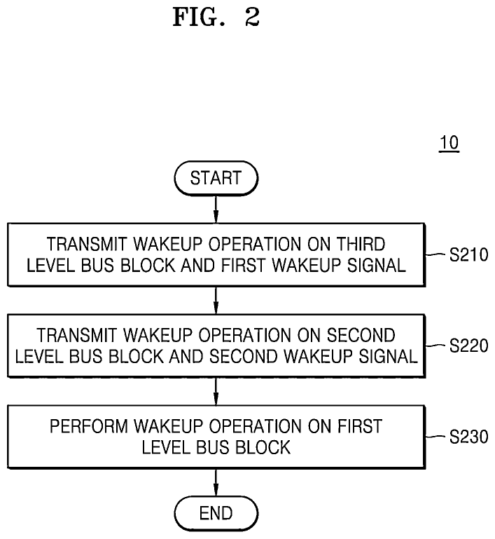

FIG. 2 is a flowchart illustrating an operating method 10 of the semiconductor system 1a according to an embodiment. As shown in FIG. 2, the operating method 10 of the semiconductor system 1a may include a plurality of operations S210 to S230.

Referring to FIGS. 1 and 2, a wakeup operation on a third level bus block and a first wakeup signal may be transmitted in operation S210. In some embodiments, the first bus block 210a may be a third level bus block, the second bus block 220a may be a second level bus block, and the third bus block 230a may be a first level bus block. The first bus block 210a may transmit the first wakeup signal to the second bus block 220a while performing the wakeup operation on the first bus block 210a.

In operation S220, the wakeup operation on the second level bus block and a second wakeup signal may be transmitted. In some embodiments, the second bus block 220a may transmit the second wakeup signal to the third bus block 230a while performing the wakeup operation on the second bus block 220a in response to the first wakeup signal.

In operation S230, the wakeup operation on the first level bus block may be performed. In some embodiments, the third bus block 220a may perform the wakeup operation on the third bus block 230a in response to the second wakeup signal.

In some embodiments, a lower level bus block may further include a hierarchical register for masking a wakeup signal transmitted to a higher level bus block. An embodiment related to the hierarchical register is described below with reference to FIGS. 4 to 6.

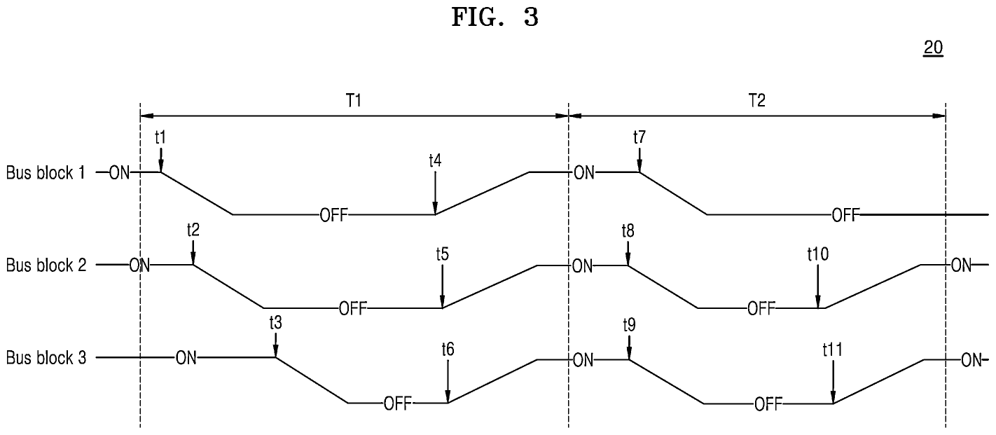

FIG. 3 is a first graph 20 illustrating an operating method of the semiconductor system 1a according to an embodiment.

Referring to FIGS. 1 and 3, the first graph 20 may be a graph illustrating the operating method of the semiconductor system 1a, and for explaining a process in which a master IP block that performs data communication with a lower level bus block performs a wakeup operation on a higher level bus block.

In some embodiments, a first period T1 may represent a process in which the first master IP block 110a accesses the memory 300a when each of the first to third bus blocks 210a, 220a, and 230a in a power off state. For example, the first bus block 210a may enter the power off state at time t1, the second bus block 220a may enter the power off state at time t2, and the third bus block 230a may enter the power off state at time t3. After the time t3, the first master IP block 110a may generate a first wakeup signal to access the memory 300a. The first bus block 210a may transmit a second wakeup signal to the second bus block 220a while performing a wakeup operation in response to the first wakeup signal at time t4. The second bus block 220a may transmit a third wakeup signal to the third bus block 230a while performing the wakeup operation in response to the second wakeup signal at time t5. The third bus block 230a may perform the wakeup operation in response to the third wakeup signal at time t6. After the time t6, the first to third bus blocks 210a, 220a, and 230a may each be in a power on state, and the first master IP block 110a may access the memory 300a through the first to third bus blocks 210a, 220a, and 230a.

In some embodiments, a second period T2 may represent a process in which the second master IP block 120a accesses the memory 300a when the first to third bus blocks 210a, 220a, and 230a each is in the power off state. For example, the first bus block 210a may enter the power off state at time t7, the second bus block 220a may enter the power off state at time t8, and the third bus block 230a may enter the power off state at time t9. After the time t9, the second master IP block 120a may generate a fourth wakeup signal to access the memory 300a. The second bus block 220a may transmit a fifth wakeup signal to the third bus block 230a while performing the wakeup operation in response to the fourth wakeup signal at time t10. The third bus block 230a may perform the wakeup operation in response to the third wakeup signal at time t11. After the time t11, the second and third bus blocks 220a and 230a may each be in the power on state, and the second master IP block 120a may access the memory 300a through the second and third bus blocks 220a and 230a. The first bus block 210a may maintain the power off state while the second master IP block 120a accesses the memory 300a.

FIG. 4 is a block diagram illustrating a semiconductor system 1b according to an embodiment.

Referring to FIG. 4, the semiconductor system 1b may include first and second master IP blocks 110b and 120b, first, second and third bus blocks 210b, 220b, and 230b, a memory 300b, an address decoder 400b, and first and second sub IP blocks 510b and 520b. Although it is shown that the semiconductor system 1b includes the first and second master IP blocks 110b and 120b, the first to third bus blocks 210b, 220b, and 230b, and the first and second sub IP blocks 510b and 520b, the semiconductor system 1b may include more master IP blocks, more bus blocks, and more sub IP blocks.

The first and second Master IP blocks 110b and 120b, the first to third bus blocks 210b, 220b, and 230b, and the memory 300b may respectively correspond to the first and second master IP blocks 110a and 120a, the first to third bus blocks 210a, 220a, and 230a, and the memory 300a of FIG. 1, and thus, descriptions redundant with those given in FIG. 1 are omitted.

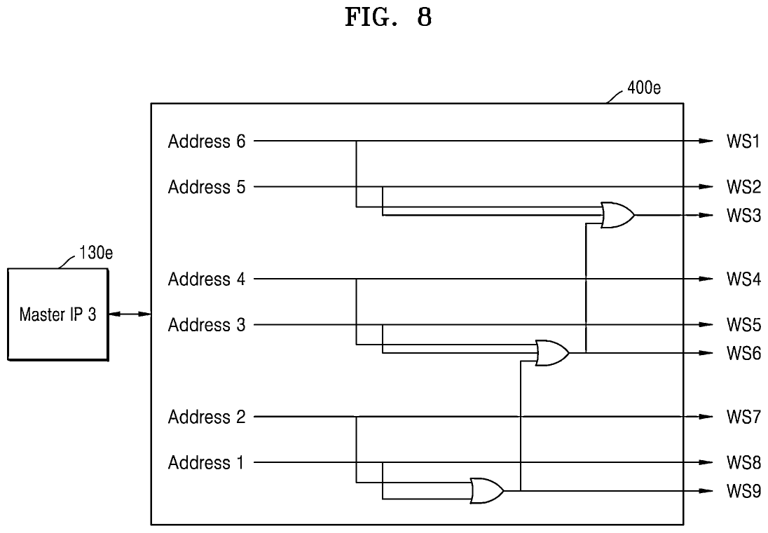

The address decoder 400b may generate an address wakeup signal based on addresses of the first and second sub IP blocks 510b and 520b. The address wakeup signal may include a wakeup signal transmitted to at least one block. For example, when the first master IP block 110b attempts to access the second sub IP block 520b, the address decoder 400b may respectively transmit wakeup signals to the first and second bus blocks 210b and 220b, and the second sub IP block 520b based on a signal received from the first master IP block 110b. An embodiment of the address decoder 400b is described below with reference to FIG. 8.

The first and second sub IP blocks 510b and 520b may be function blocks that perform specific functions. The first sub IP block 510b may perform data communication with the first bus block 210b, and the second sub IP block 520b may perform data communication with the second bus block 220b.

The first PMU 211b may include a first hierarchical register 211_1b. In some embodiments, the first hierarchical register 211_1b may mask a wakeup signal transmitted from the first PMU 211b to the second PMU 221b in response to the address wakeup signal generated by the address decoder 400. Masking may refer to an operation of blocking a transmitted signal. For example, when the first master IP block 110b accesses the first sub IP block 510b, the address decoder 400b may generate the address wakeup signal including the wakeup signals transmitted to the first bus block 210b and the first sub IP block 510b in response to the signal received from the first master IP block 110b. Because the first sub IP block 510b is a block at the same level as the first bus block 210b, the wakeup operation on blocks at a higher level than the first bus block 210b may be unnecessary. Accordingly, the first hierarchical register 211_1b may mask the wakeup signal transmitted from the first PMU 211b to the second PMU 221b in response to the generated address wakeup signal, and the second bus block 220b may maintain the power off state.

The second PMU 221b may include a second hierarchical register 221_b. In some embodiments, the second hierarchical register 221_1b may mask the wakeup signal transmitted from the second PMU 221b to the third PMU 231b in response to the address wakeup signal generated by the address decoder 400. For example, when the first master IP block 110b accesses the second sub IP block 520b, the address decoder 400b may generate the address wakeup signal including the wakeup signals transmitted to the first bus block 210b, the second bus block 220b, and the second sub IP block 520b in response to the signal received from the first master IP block 110b. Because the second sub IP block 520b is a block at the same level as the second bus block 220b, the wakeup operation on blocks at a higher level than the second bus block 220b may be unnecessary. Accordingly, the second hierarchical register 221_1b may mask the wakeup signal transmitted from the second PMU 221b to the third PMU 231b in response to the generated address wakeup signal, and the third bus block 230b may maintain the power off state.

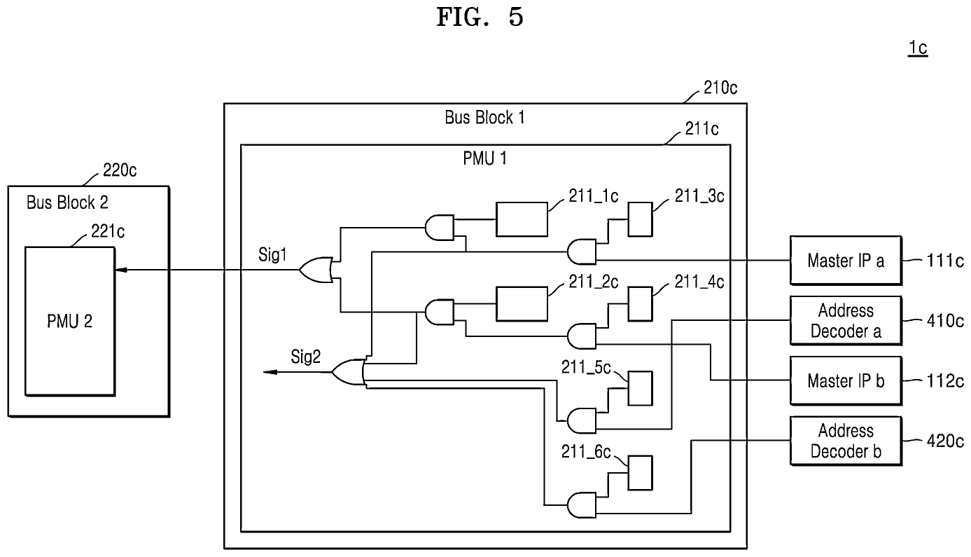

FIG. 5 is a block diagram illustrating a semiconductor system 1c according to an embodiment.

Referring to FIG. 5, the semiconductor system 1c may include first master IP blocks 111c and 112c, first and second bus blocks 210c and 220c, and address decoders 410c and 420c. Although it is shown that the semiconductor system 1c includes the first master IP blocks 111c and 112c, the first and second bus blocks 210c and 220c, and the address decoders 410c and 420c, the semiconductor system 1c may include more first master IP blocks, more bus blocks, and more address decoders.

The first master IP blocks 111c and 112c may correspond to the first master IP block 110b in FIG. 4, the address decoders 410c and 420c may correspond to the address decoder 400b in FIG. 4, and the first and second bus blocks 210c and 220c may correspond to the first and second bus blocks 210b and 220b of FIG. 4, and thus, descriptions redundant with those given in FIG. 4 are omitted.

The first PMU 211c may include first hierarchical registers 211_1c and 211_2c, enable registers 211_3c, 211_4c, 211_5c, and 211_6c, a plurality of AND gates, and a plurality of OR gates.

The first hierarchical registers 211_1c and 211_2c may correspond to the first hierarchical register 211_1b in FIG. 4. Descriptions redundant with those given in FIG. 4 are omitted. In some embodiments, the first hierarchical registers 211_1c and 211_2c may be respectively correspond to the first master IP blocks 111c and 112c that perform data communication with the first bus block 210c. For example, the first hierarchical register 211_1c may correspond to the first master IP block 111c, and the first hierarchical register 211_2c may correspond to the first master IP block 112c.

In some embodiments, the first hierarchical register 211_1c may mask a wakeup signal sig1 transmitted from the first PMU 211c to the second PMU 221c in response to an address wakeup signal generated by the address decoder 410c. For example, when the first master IP block 111c accesses a first sub IP block that communicates data with the first bus block 210c, the first hierarchical register 211_1c may generate a signal of a first level (e.g., 0) in response to the address wakeup signal generated by the address decoder 410c. The wakeup signal sig1 transmitted from the first PMU 211c to the second PMU 221c may be masked based on the signal of the first level. For example, when the first master IP block 111c accesses a second sub IP block that communicates data with the second bus block 220c, the first hierarchical register 211_1c may generate a signal of a second level (e.g., 1) in response to the address wakeup signal generated by the address decoder 410c. The wakeup signal sig1 transmitted from the first PMU 211c to the second PMU 221c may be generated based on the signal of the second level. The first hierarchical register 211_2c may operate on the same principle as the first hierarchical register 211_1c.

In some embodiments, the enable registers 211_3c, 211_4c, 211_5c, and 211_6c may each correspond to the first master IP block 111c or 112c or the address decoder 410c or 420c, and may control the first PMU 211c to generate the wakeup signal sig1 or sig2 based on the signal generated by the first master IP block 111c or 112c or the address decoder 410c or 420c. For example, the enable register 211_3c corresponding to the first master IP block 111c may generate a signal of the first level (e.g., 0), and the first PMU 211c may ignore the signal generated by the first master IP block 111c based on the signal of the first level. For example, the enable register 211_3c corresponding to the first master IP block 111c may generate a signal of the second level (e.g., 1), and, the first PMU 211c may generate the wakeup signal sig1 or sig2 based on the signal generated by the first master IP block 111c based on the signal of the second level. In other words, the first PMU 211c may ignore a first level signal of the first master IP block 111c, but generate a wakeup signal based on the second level signal of the first master IP block 111c. The enable register 211_4c, 211_5c, or 211_6c may operate on the same principle as the enable register 211_3c.

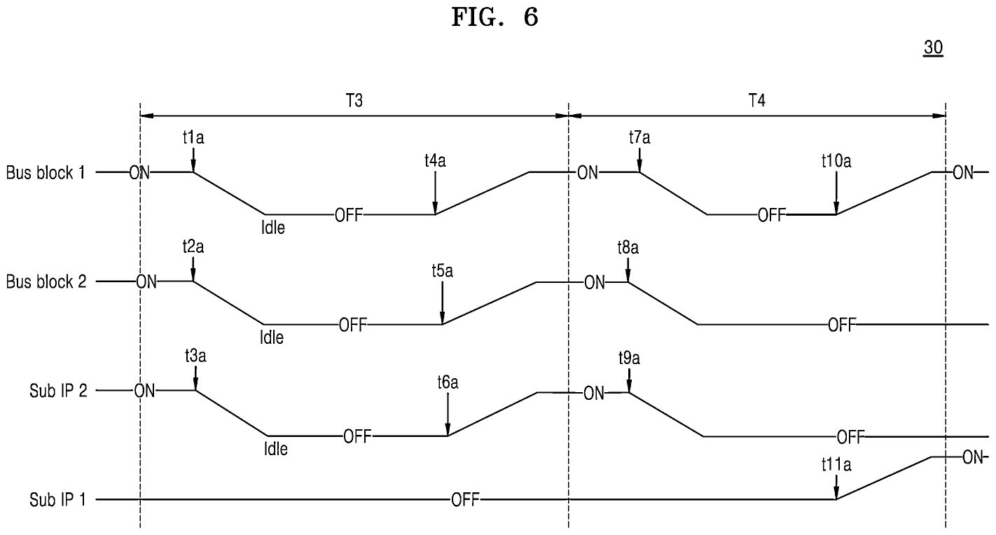

FIG. 6 is a second graph 30 illustrating an operating method of the semiconductor system 1b according to an embodiment.

Referring to FIGS. 4 and 6, the second graph 30 may be a graph illustrating the operating method of the semiconductor system 1b, and for explaining a process in which a master IP block that performs data communication with a lower level bus block performs a wakeup operation on a higher level bus block or a same level bus block.

In some embodiments, a third period T3 may represent a process in which the first master IP block 110b accesses the second sub IP block 520b when each of the first and second bus blocks 210b and 220b and the first and second sub IP blocks 510b and 520b are in a power off state.

For example, the first bus block 210b may enter the power off state at time t1a, the second bus block 220b may enter the power off state at time t2a, the second sub IP block 520b may enter the power off state at time t3a, and the first sub IP block 510b may maintain the power off state. After the time t3a, the first master IP block 110b may transmit a control signal to the address decoder 400b to access the second sub IP block 520b, and transmit a wakeup signal to the first PMU 211b. After receiving the control signal, the address decoder 400b may generate an address wakeup signal including wakeup signals to be transmitted to the second bus block 220b and the second sub IP block 520b based on an address of the second sub IP block 520b. The first PMU 211b may perform a wakeup operation on the first bus block 210b in response to the wakeup signal received from the first master IP block 110b at time t4a, and the first hierarchical register 211_1b may mask the wakeup signal transmitted from the first PMU 211b to the second PMU 221b in response to the address wakeup signal. The second PMU 221b may perform the wakeup operation on the second bus block 220b in response to the address wakeup signal at time t5a. The second sub IP block 520b may perform the wakeup operation in response to the address wakeup signal at time t6a. Because the address decoder 400b generates the wakeup signals to be transmitted to the second bus block 220b and the second sub IP block 520b in parallel, the time t5a may be the same as the time t6a.

For example, after the time t3a, the first master IP block 110b may transmit a control signal to the address decoder 400b to access the second sub IP block 520b. After receiving the control signal, the address decoder 400b may generate an address wakeup signal including the wakeup signals to be transmitted to the first bus block 210b, the second bus block 220b, and the second sub IP block 520b based on the address of the second sub IP block 520b. The first PMU 211b may perform the wakeup operation on the first bus block 210b in response to the address wakeup signal at the time t4a, and the first hierarchical register 211_1b may mask the wakeup signal transmitted from the first PMU 211b to the second PMU 221b in response to the address wakeup signal. The subsequent process may be the same as described above.

In some embodiments, a fourth period T4 may represent a process in which the first master IP block 110b accesses the first sub IP block 510b when each of the first and second bus blocks 210b and 220b and the first and second sub IP blocks 510b and 520b are in the power off state.

For example, the first bus block 210b may enter the power off state at time t7a, the second bus block 220b may enter the power off state at time t8a, the second sub IP block 520b may enter the power off state at time t9a, and the first sub IP block 510b may maintain the power off state. Time t8a and t9a may be the same. Further, the t7a may occur after the time t8a and t9a. After the time t9a, the first master IP block 110b may transmit the control signal to the address decoder 400b to access the first sub IP block 510b, and transmit the wakeup signal to the first PMU 211b. After receiving the control signal, the address decoder 400b may generate an address wakeup signal including wakeup signals to be transmitted to the first sub IP block 510b based on an address of the first sub IP block 510b. The first PMU 211b may perform the wakeup operation on the first bus block 210b in response to the wakeup signal received from the first master IP block 110b at time t10a, and the first hierarchical register 211_1b may mask the wakeup signal transmitted from the first PMU 211b to the second PMU 221b in response to the address wakeup signal. The first sub IP block 510b may perform the wakeup operation in response the address wakeup signal at time t11a.

For example, after the time t9a, the first master IP block 110b may transmit a control signal to the address decoder 400b to access the first sub IP block 510b. After receiving the control signal, the address decoder 400b may generate an address wakeup signal including the wakeup signals to be transmitted to the first bus block 210b and the first sub IP block 510b based on the address of the first sub IP block 510b. The first PMU 211b may perform the wakeup operation on the first bus block 210b in response to the address wakeup signal at the time t10a, and the first hierarchical register 211_1b may mask the wakeup signal transmitted from the first PMU 211b to the second PMU 221b in response to the address wakeup signal. The subsequent process may be the same as described above. The second bus block 220b and the second sub IP block 520b may maintain the power off state prior to and after the time t10a. Because the address decoder 400b generates the wakeup signals to be transmitted to the first bus block 210b and the first sub IP block 510b in parallel, the time t10a may be the same as the time t11a.

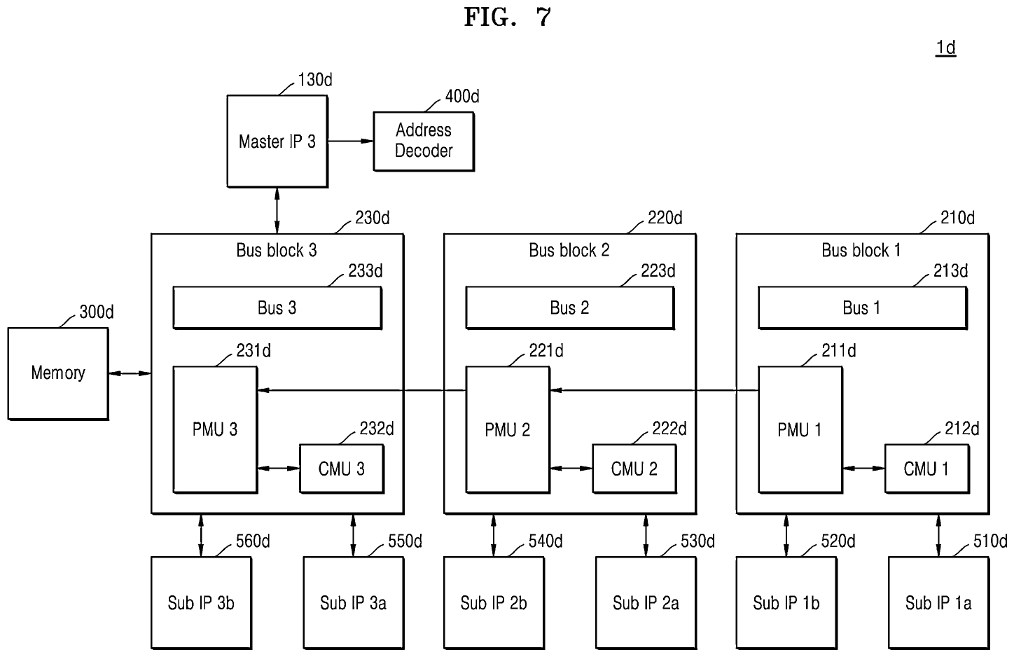

FIG. 7 is a block diagram illustrating a semiconductor system 1d according to an embodiment.

Referring to FIG. 7, the semiconductor system 1d may include a third master IP block 130d, first, second and third bus blocks 210d, 220d, and 230d, a memory 300d, an address decoder 400d, and first sub IP blocks 510d and 520d, second sub IP blocks 530d and 540d, and third sub IP blocks 550d and 560d. Although it is shown that the semiconductor system 1d includes the third master IP block 130d, the first to third bus blocks 210d, 220d, and 230d, the first sub IP blocks 510d and 520d, the second sub IP blocks 530d and 540d, and the third sub IP blocks 550d and 560d, the semiconductor system 1d may include more master IP blocks, more bus blocks, and more sub IP blocks.

The third master IP block 130d and the first to third bus blocks 210d, 220d, and 230d, and memory 300d may respectively correspond to the third master IP block 130a, the first to third bus blocks 210a, 220a, and 230a, and the memory 300a of FIG. 1, and the address decoder 400d may correspond to the address decoder 400b of FIG. 4, and thus, descriptions redundant with those given in FIGS. 1 and 4 are omitted.

The first sub IP blocks 510d and 520d, the second sub IP blocks 530d and 540d, and the third sub IP blocks 550d and 560d may be function blocks that perform specific functions. The first sub IP blocks 510d and 520d may perform data communication with the first bus block 210d, and the second sub IP blocks 530d and 540d may perform data communication with the second bus block 220d. The third sub IP blocks 550d and 560d may perform data communication with the third bus block 230d.

The address decoder 400d may generate an address wakeup signal based on addresses of the first sub IP blocks 510d and 520d, the second sub IP blocks 530d and 540d, and the third sub IP blocks 550d and 560d after receiving a control signal from the third master IP block 130d. The address wakeup signal may include a wakeup signal transmitted to at least one block. An embodiment of the address decoder 400d is described below with reference to FIGS. 7 and 8.

FIG. 8 is a block diagram illustrating an address decoder 400e of a semiconductor system according to an embodiment. A third master IP block 130e and the address decoder 400e of FIG. 8 may correspond to the third master IP block 130d and the address decoder 400d of FIG. 7, and thus, descriptions redundant with those given in FIG. 7 are omitted.

Referring to FIG. 8, the address decoder 400e may include a plurality of OR gates and generate an address wakeup signal based on addresses of sub IP blocks. In some embodiments, further referring to FIG. 7, each of the first sub IP blocks 510d and 520d, the second sub IP blocks 530d and 540d, and the third sub IP blocks 550d and 560d may correspond to a specific address. For example, the first sub IP block 510d may correspond to a first address 1, the first sub IP block 520d may correspond to a second address 2, the second sub IP block 530d may correspond to a third address 3, the second sub IP block 540d may correspond to a fourth address 4, the third sub IP block 550d may correspond to a fifth address 5, and the third sub IP block 560d may correspond to a sixth address 6.

In some embodiments, the third master IP block 130e may generate a control signal, and the address decoder 400e may generate an address wakeup signal based on the first to sixth addresses 1 to 6 of the first sub IP blocks 510d and 520d, the second sub IP blocks 530d and 540d, and the third sub IP blocks 550d and 560d after receiving the control signal.

For example, when the third master IP block 130e accesses the third sub IP block 560d, the address decoder 400e may generate a wakeup signal WS1 to be transmitted to the third sub IP block 560d based on the sixth address 6 and a wakeup signal WS3 to be transmitted to the third bus block 230d. When the third master IP block 130e accesses the third sub IP block 550d, the address decoder 400e may generate a wakeup signal WS2 to be transmitted to the third sub IP block 550d based on the fifth address 5 and the wakeup signal WS3 to be transmitted to the third bus block 230d.

For example, when the third master IP block 130e accesses the second sub IP block 540d, the address decoder 400e may generate a wakeup signal WS4 to be transmitted to the second sub IP block 540d based on the fourth address 4, a wakeup signal WS6 to be transmitted to the second bus block 220d, and the wakeup signal WS3 to be transmitted to the third bus block 230d. When the third master IP block 130e accesses the second sub IP block 530d, the address decoder 400e may generate a wakeup signal WS5 to be transmitted to the second sub IP block 530d based on the third address 3, the wakeup signal WS6 to be transmitted to the second bus block 220d, and the wakeup signal WS3 to be transmitted to the third bus block 230d.

For example, when the third master IP block 130e accesses the first sub IP block 520d, the address decoder 400e may generate a wakeup signal WS7 to be transmitted to the first sub IP block 520d based on the second address 2, a wakeup signal WS9 to be transmitted to the first bus block 210d, the wakeup signal WS6 to be transmitted to the second bus block 220d, and the wakeup signal WS3 to be transmitted to the third bus block 230d. When the third master IP block 130e accesses the first sub IP block 510d, the address decoder 400e may generate a wakeup signal WS8 to be transmitted to the first sub IP block 510d based on the first address 1, the wakeup signal WS9 to be transmitted to the first bus block 210d, the wakeup signal WS6 to be transmitted to the second bus block 220d, and the wakeup signal WS3 to be transmitted to the third bus block 230d.

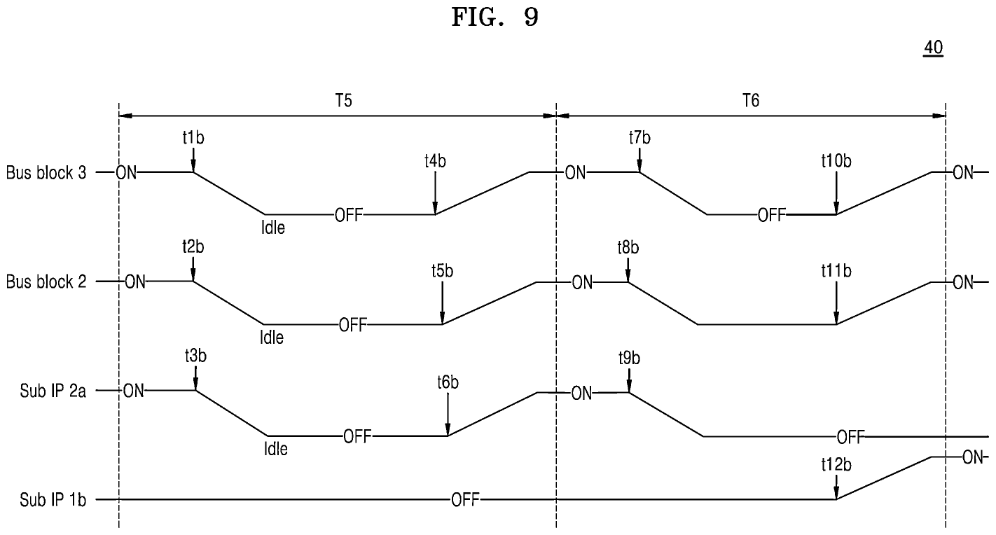

FIG. 9 is a third graph 40 illustrating an operating method of the semiconductor system 1d according to an embodiment.

Referring to FIGS. 7 to 9, the third graph 40 may be a graph illustrating the operating method of the semiconductor system 1d, and for explaining a process in which a master IP block that performs data communication with a higher level bus block performs a wakeup operation on a lower level bus block.

In some embodiments, a fifth period T5 may represent a process in which the third master IP block 130d accesses the second sub IP block 530d when each of the second and third bus blocks 220d and 230d and the second sub IP blocks 530d and 540d are in a power off state.

For example, the third bus block 230d may enter the power off state at time t1b, the second bus block 220d may enter the power off state at time t2b, the second sub IP block 530d may enter the power off state at time t3b, and the second sub IP block 540d may maintain the power off state. The times t1b, t2b and t3b may be the same as each other. After the time t3b, the third master IP block 130d may transmit a control signal to the address decoder 400d to access the second sub IP block 530d. After receiving the control signal, the address decoder 400d may generate an address wakeup signal including wakeup signals (e.g., the wakeup signals WS6, WS3, and WS5 in FIG. 8) to be transmitted to the second bus block 220d, the third bus block 230b, and the second sub IP block 530d based on an address (e.g., the third address 3 of FIG. 8) of the second sub IP block 530b. The third PMU 231d may perform a wakeup operation on the third bus block 230d in response to an address wakeup signal (e.g., the wakeup signal WS3 in FIG. 8) at time t4b. The second PMU 221d may perform the wakeup operation on the second bus block 220d in response to an address wakeup signal (e.g., the wakeup signal WS6 in FIG. 8) at time t5b. The second sub IP block 530d may perform the wakeup operation in response to an address wakeup signal (e.g., the wakeup signal WS5 in FIG. 8) at time t6b. Because the address decoder 400d generates wakeup signals (e.g., the wakeup signals WS6, WS3, and WS5) to be transmitted to the second bus block 220d, the third bus block 230d, and the second sub IP block 530d in parallel, the time t4b may be the same as the time t5b and the time t6b. In some cases, however, the time t4b, the time t5b and the time t6b may be different from each other.

In some embodiments, a sixth period T6 may represent a process in which the third master IP block 130d accesses the second sub IP block 540d when each of the second and third bus blocks 220d and 230d and the second sub IP blocks 530d and 540d are in a power off state.

For example, the third bus block 230d may enter the power off state at time t7b, the second bus block 220d may enter the power off state at time t8b, the second sub IP block 530d may enter the power off state at time t9b, and the second sub IP block 540d may maintain the power off state. After the time t9b, the third master IP block 130d may transmit a control signal to the address decoder 400d to access the second sub IP block 540d. After receiving the control signal, the address decoder 400d may generate an address wakeup signal including wakeup signals (e.g., the wakeup signals WS6, WS3, and WS4 in FIG. 8) to be transmitted to the second bus block 220d, the third bus block 230b, and the second sub IP block 540d based on an address (e.g., the fourth address 4 of FIG. 8) of the second sub IP block 540b. The third PMU 231d may perform the wakeup operation on the third bus block 230d in response to the address wakeup signal (e.g., the wakeup signal WS3 in FIG. 8) at the time t7b. The second PMU 221d may perform the wakeup operation on the second bus block 220d in response to the address wakeup signal (e.g., the wakeup signal WS6 in FIG. 8) at time t11b. The second sub IP block 540d may perform the wakeup operation in response to the address wakeup signal (e.g., the wakeup signal WS4 in FIG. 8) at time t12b. Because the address decoder 400d generates wakeup signals (e.g., the wakeup signals WS6, WS3, and WS4) to be transmitted to the second bus block 220d, the third bus block 230d, and the second sub IP block 530d in parallel, the time t10b may be the same as the time t11b and the time t12b.

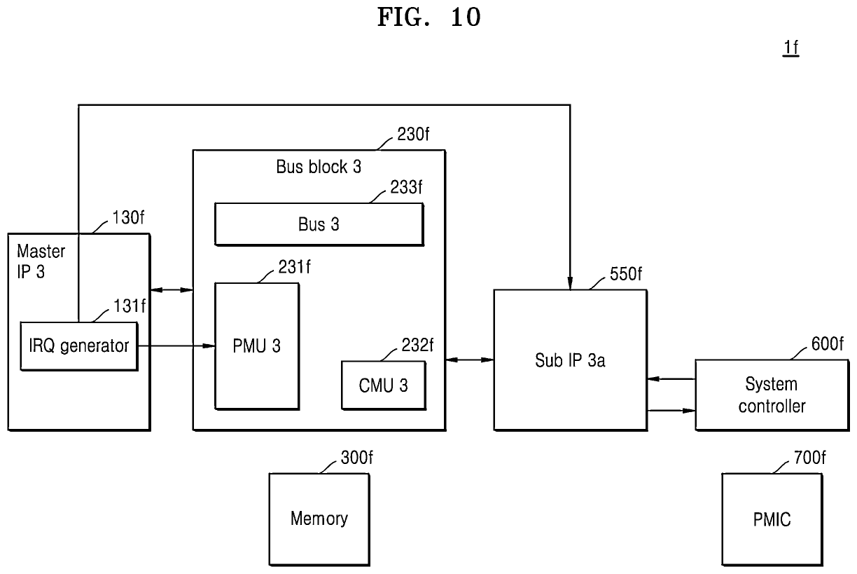

FIG. 10 is a block diagram illustrating a semiconductor system 1f according to an embodiment.

Referring to FIG. 10, the semiconductor system 1f may include a third master IP block 130f, a third bus block 230f, a memory 300f, a third sub IP block 550f, a system controller 600f, and a power management integrated circuit (PMIC) 700f. Although it is shown that the semiconductor system 1f includes the third master IP block 130f, the third bus block 230f, the memory 300f, the third sub IP block 550f, the system controller 600f, and the PMIC 700f, the semiconductor system 1f may include more first master IP blocks, more bus blocks, and more sub IP blocks.

The third master IP block 130f, the third bus block 230f, the memory 300f, and the third sub IP block 550f may correspond to the third master IP block 130d, the third bus block 230d, the memory 300d, and the third sub IP block 550d of FIG. 7, and thus, descriptions redundant with those given in FIG. 7 are omitted.

The third master IP block 130f may include an Interrupt ReQuest (IRQ) generator 131f. The IRQ generator 131f may transmit a wakeup signal to a block correlated to the third master IP block 130f before the third master IP block 130f operates. In this specification, the third master IP block 130f includes the IRQ generator 131f, but is not limited thereto. For example, the IRQ generator 131f may be located outside the third master IP block 130f.

In some embodiments, the third sub IP block 550f may be a block correlated to the third master IP block 130f, and the IRQ generator 131f may transmit a wakeup signal to the third sub IP block 550f before performing a wakeup operation on the third master IP block 130f. For example, when the third master IP block 130f operates, the third sub IP block 550f may operate together. In this case, the third sub IP block 550f may be referred to as the block correlated to the third master IP block 130f. The IRQ generator 131f may transmit the wakeup signal to the third sub IP block 550f before performing the wakeup operation on the third master IP block 130f.

In some embodiments, the IRQ generator 131f may transmit the wakeup signal faster than a period of the third sub IP block 550f when the third master IP block 130f operates. In other words, when third master IP block 130f operates, the IRQ generator 131f can transmit the wakeup signal more quickly than the operating period of the third sub IP block 550f. For example, the third sub IP block 550f may be a block that operates periodically, and an operation period of the third sub IP block 550f may be T ms (T is a natural number). The IRQ generator 131f may transmit the wakeup signal to the third sub IP block 550f faster than T ms.

In the semiconductor system 1f of the inventive concept, the IRQ generator 131f may perform an early wakeup operation of waking up in advance another block (e.g., the third sub IP block 550f) correlated to a specific block (e.g., the third master IP block 130f), and thus, the time required to perform a power on operation for each of a plurality of blocks may be reduced, thereby enhancing the performance of the semiconductor system 1f.

The system controller 600f may perform a locking setting operation or an unlocking operation on a specific block. A plurality of blocks connected to a specific bus block may share a supplied power voltage, and the locking setting operation may be an operation of lowering the power voltage supplied to a specific block that uses the shared power voltage more than necessary. The unlocking operation may be an operation of releasing the locking setting operation. In some embodiments, the system controller 600f may perform the locking setting operation or the unlocking operation on the third sub IP block 550f. For example, the third sub IP block 550f may receive a control signal from the IRQ generator 131f and may transmit locking information to the system controller 600f based on the received control signal. The system controller 600f may perform the unlocking operation on the third sub IP block 550f when the locking information is at a first level (e.g., a low level), and perform the locking setting operation on the third sub IP block 550f when the locking information is at a second level (e.g., a high level).

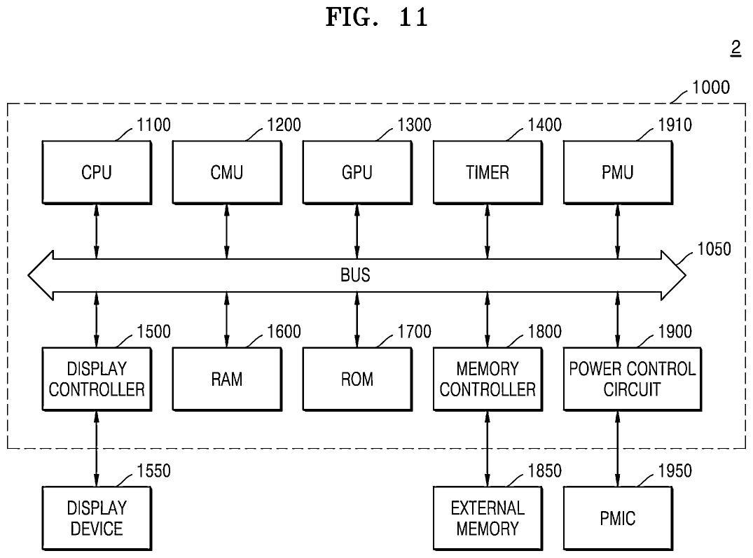

FIG. 11 is a block diagram illustrating an electronic device 2 according to an embodiment.

Referring to FIG. 11, the electronic device 2 may be implemented as a handheld device such as a mobile phone, a smartphone, a tablet PC, a PDA, an enterprise digital assistant EDA, a digital still camera, a digital video camera, a PMP, a PND, a handheld game console, or e-book.

The electronic device 2 may include a SoC 1000, an external memory 1850, a display device 1550, and a power management integrated circuit (PMIC) 1950.

The SoC 1000 may include a central processing unit (CPU) 1100, a clock management unit (CMU) 1200, a graphics processing unit (GPU) 1300, a timer 1400, a display controller 1500, a random access memory (RAM) 1600, a read only memory (ROM) 1700, a memory controller 1800, a power management unit (PMU) 1910, a power control circuit 1900 and a bus 1050. The SoC 1000 may further include other components in addition to the components shown. For example, the electronic device 2 may further include the display device 1550, the external memory 1850, and the PMIC 1950. The PMIC 1950 may be implemented outside of the SoC 1000. However, the SoC 1000 is not limited thereto and may include the PMU capable of performing a function of the PMIC 1950.

The CPU 1100 may also be referred to as a processor and may process or execute programs and/or data stored in the external memory 1850. For example, the CPU 1100 may process or execute programs and/or data in response to an operation clock signal output from the CMU 1200.

The CPU 1100 may be implemented as a multi-core processor. The multi-core processor may be one computing component having two or more independent physical processors (referred to as ‘cores’), and each of the processors may read and execute program instructions. The programs and/or data stored in the ROM 1700, the RAM 1600, and/or the external memory 1850 may be loaded into a memory of the CPU 1100 as needed.

The CMU 1200 may generate an operation clock signal. The CMU 1200 may include a clock signal generating device, such as a phase locked loop (PLL), a delayed locked loop (DLL), or a crystal oscillator.

The operation clock signal may be supplied to the GPU 1300. The operation clock signal may be supplied to other components (e.g., the CPU 1100 or the memory controller 1800, etc.) The CMU 1200 may change a frequency of the operation clock signal.

The GPU 1300 may convert data read from the external memory 1850 by the memory controller 1800 into a signal suitable for the display device 1550.

The timer 1400 may output a count value indicating time based on the operation clock signal output from the CMU 1200.

The display device 1550 may display image signals output from the display controller 1500. For example, the display device 1550 may be implemented as a liquid crystal display (LCD), a light emitting diode (LED) display, an organic LED (OLED) display, an active-matrix OLED (AMOLED) display, or a flexible display. The display controller 1500 may control an operation of the display device 1550.

The RAM 1600 may temporarily store programs, data, or instructions. For example, the programs and/or data stored in the memory may be temporarily stored in the RAM 1600 by the control of the CPU 1100 or according to a booting code stored in the ROM 1700. The RAM 1600 may be implemented as dynamic RAM (DRAM) or static RAM (SRAM).

The ROM 1700 may store permanent programs and/or data. The ROM 1700 may be implemented as erasable programmable read-only memory (EPROM) or electrically erasable programmable read-only memory (EEPROM).

The memory controller 1800 may communicate with the external memory 1850 through an interface. The memory controller 1800 may control all operations of the external memory 1850 and control data exchange between a host and the external memory 1850. For example, the memory controller 1800 may write data to or read data from the external memory 1850 at a request of the host. Here, the host may be a master device such as the CPU 1100, the GPU 1300, or the display controller 1500.

The external memory 1850 is a storage medium for storing data, and may store an operating system (OS), various programs, and/or various data. The external memory 1850 may be, for example, DRAM, but is not limited thereto. For example, the external memory 1850 may be a non-volatile memory device (e.g., flash memory, phase change RAM (PRAM), magnetic RAM (MRAM), resistive RAM (RRAM), or ferroelectric RAM (FeRAM) device). In another embodiment, the external memory 1850 may be an internal memory provided inside the SoC 1000. In addition, the external memory 1850 may be flash memory, embedded multimedia card (eMMC), or universal flash storage (UFS).

The PMU 1910 may control a voltage required for each device connected to the SoC 1000 to operate. In some embodiments, the SoC 1000 may include a plurality of blocks (e.g., the CPU 1100, the GPU 1300, or the bus 1050), and PMU 1910 may perform a power on/off operation on each of the plurality of blocks. The PMU 1910 may be the same as one of the first to third PMUs 211a, 221a, and 231a described above in FIG. 1. For example, the PMU 1910 may perform a power on operation in parallel on the CPU 1100, the GPU 1300, or the bus 1050 that are in a power off state, which may reduce the time required to perform the power on operation, thereby enhancing the performance of the electronic device 2.

The CPU 1100, the CMU 1200, the GPU 1300, the timer 1400, the display controller 1500, the RAM 1600, the ROM 1700, the memory controller 1800, the power control circuit 1900, the PMU 1910 may communicate with each other via the bus 1050.

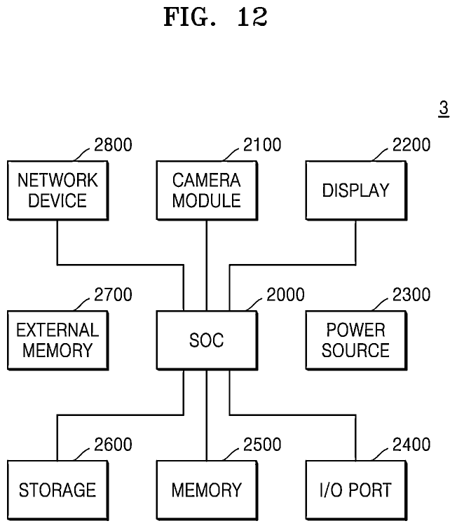

FIG. 12 is a block diagram illustrating an electronic device 3 according to an embodiment.

Referring to FIG. 12, the electronic device 3 may be implemented as a PC, a data server, or a portable electronic device.

The electronic device 3 may include a SoC 2000, a camera module 2100, a display 2200, a power source 2300, an input/output (I/O) port 2400, a memory 2500, a storage 2600, an external memory 2700, and a network device 2800.

The SoC 2000 may include a plurality of blocks (e.g., the CPU 1100, the GPU 1300, or the bus 1050 of FIG. 11), and may perform a power on operation in parallel on each of the plurality of blocks. The SoC 2000 may include one of the first to third PMUs 211a, 221a, and 231a described above in FIG. 1. For example, the SoC 2000 may perform the power on operation in parallel on each of the plurality of blocks (the CPU 1100, the GPU 1300, or the bus 1050 of FIG. 11), that are in a power off state, which may reduce the time required to perform the power on operation on each of the plurality of blocks, thereby enhancing the performance of the electronic device 3.

The camera module 2100 may be a module capable of converting an optical image into an electrical image. Accordingly, the electrical image output from the camera module 2100 may be stored in the storage 2600, the memory 2500, or the external memory 2700. In addition, the electrical image output from the camera module 2100 may be displayed through the display 2200.

The display 2200 may display data output from the storage 2600, the memory 2500, the I/O port 2400, the external memory 2700, or the network device 2800. The display 2200 may be the display device 1550 shown in FIG. 11.

The power source 2300 may supply an operating voltage to at least one of the components. The power source 2300 may be controlled by the PMIC 1950 shown in FIG. 11.

The I/O port 2400 may include ports capable of transmitting data to the electronic device 1 or transmitting data output from the electronic device 2 to an external device. For example, the I/O port 2400 may include a port for connecting a pointing device such as a computer mouse, a port for connecting a printer, or a port for connecting a USB drive.

The memory 2500 may be implemented as volatile memory or non-volatile memory. According to an embodiment, a memory controller capable of controlling a data access operation on the memory 2500, such as a read operation, a write operation (or a program operation), or an erase operation, may be integrated or embedded in the SoC 2000. According to another embodiment, the memory controller may be implemented between the SoC 2000 and the memory 2500.

The storage 2600 may be implemented as a hard disk drive or solid state drive (SSD).

The external memory 2700 may be implemented as a secure digital (SD) card or a multimedia card (MMC). According to an embodiment, the external memory 2700 may be a subscriber identification module (SIM) card or a universal subscriber identity module (USIM) card.

The network device 2800 may be a device capable of connecting the electronic device 3 to a wired network or a wireless network.

While the inventive concept has been particularly shown and described with reference to embodiments thereof, it will be understood that various changes in form and detail may be made thereto without departing from the spirit and scope of the inventive concept as set forth in the following claims.

What is claimed is:

1. A semiconductor system comprising:
a memory to store data;
a first master intellectual property (IP) block configured to generate a first wakeup signal;
a first bus block configured to generate a second wakeup signal while performing a wakeup operation in response to the first wakeup signal;
a second bus block configured to generate a third wakeup signal while performing the wakeup operation in response to the second wakeup signal; and
a third bus block configured to perform data communication with the memory and perform the wakeup operation in response to the third wakeup signal.

2. The semiconductor system of claim 1, wherein
the first bus block includes
a first bus configured to perform data communication with the first master IP block; and
a first power management unit (PMU) configured to generate the second wakeup signal while performing the wakeup operation in response to the first wakeup signal,
the second bus block includes
a second bus configured to perform data communication with the first bus; and
a second PMU configured to generate the third wakeup signal while performing the wakeup operation in response to the second wakeup signal,
the third bus block includes
a third bus configured to perform data communication with the second bus and the memory; and
a third PMU configured to perform the wakeup operation in response to the third wakeup signal.

3. The semiconductor system of claim 2, further comprising: a second master IP block configured to generate a fourth wakeup signal and perform data communication with the second bus,
wherein the second PMU is configured to generate a fifth wakeup signal while performing the wakeup operation in response to the fourth wakeup signal, and
the third PMU is configured to perform the wakeup operation in response to the fifth wakeup signal.

4. The semiconductor system of claim 2, further comprising:
a plurality of sub IP blocks; and
an address decoder configured to generate an address wakeup signal based on address information of each of the plurality of sub IP blocks,
wherein the first PMU includes a first hierarchical register configured to mask the second wakeup signal in response to the address wakeup signal.

5. The semiconductor system of claim 4, wherein the second PMU includes a second hierarchical register configured to mask the third wakeup signal in response to the address wakeup signal.

6. The semiconductor system of claim 5, wherein
the address decoder is configured to generate the address wakeup signal based on address information of a first sub IP block that performs data communication with the second bus block among the plurality of sub IP blocks,
the first PMU is configured to generate the second wakeup signal by using the first hierarchical register that generates a high level signal in response to the address wakeup signal,
the second PMU is configured to mask the third wakeup signal by using the second hierarchical register that generates a low level signal in response to the address wakeup signal, and
the first sub IP block is configured to perform the wakeup operation in response to the address wakeup signal.

7. The semiconductor system of claim 1, further comprising:
a third master IP block configured to generate a sixth wakeup signal and perform data communication with the third bus block;
a plurality of sub IP blocks; and
an address decoder configured to generate an address wakeup signal based on address information of a specific sub IP block among the plurality of sub IP blocks,
wherein the third bus block is configured to perform the wakeup operation in response to the sixth wakeup signal, and
the specific sub IP block is configured to perform the wakeup operation in response to the address wakeup signal.

8. The semiconductor system of claim 7, wherein
the specific sub IP block is configured to perform data communication with the second bus block, and
the second bus block is configured to perform the wakeup operation in response to the address wakeup signal.

9. The semiconductor system of claim 7, wherein
the second bus block includes
a second bus; and
a second power management unit (PMU) configured to perform the wakeup operation in response to the address wakeup signal,
the third bus block includes
a third bus configured to perform data communication with the second bus and the third master IP block; and
a third PMU configured to perform the wakeup operation in response to the sixth wakeup signal, and
the specific sub IP block includes
a fourth bus configured to perform data communication with the second bus; and
a fourth PMU configured to perform the wakeup operation in response to the address wakeup signal.

10. The semiconductor system of claim 1, further comprising:
a third master IP block configured to generate a sixth wakeup signal and perform data communication with the third bus block; and
a first sub IP block configured to perform data communication with the third bus block,
wherein the third bus block is configured to perform the wakeup operation in response to the sixth wakeup signal, and
the third master IP block includes an interrupt request (IRQ) generator configured to transmit a seventh wakeup signal to the first sub IP block before generating the sixth wakeup signal.

11. The semiconductor system of claim 10, further comprising: a system controller configured to perform a locking setting operation or an unlocking operation on the first sub IP block,
wherein the IRQ generator is configured to transmit a control signal to the first sub IP block and control the system controller in response to the control signal.

12. The semiconductor system of claim 11, wherein
the first sub IP block is configured to transmit locking information to the system controller in response to the control signal,
the system controller is configured to
perform the unlocking operation on the first sub IP block when the locking information is at a first level, and
perform the lock setting operation on the first sub IP block when the locking information is at a second level.

13. A semiconductor system comprising:
a memory to store data;
a first level bus block configured to perform data communication with the memory;
a second level bus block configured to perform data communication with the first level bus block; and
a third level bus block configured to perform data communication with the second level bus block,
wherein the first level bus block and the second level bus block are configured to perform a wakeup operation when the wakeup operation on the third level bus block is performed.

14. The semiconductor system of claim 13, wherein
the third level bus block includes a third level power management unit (PMU) configured to generate a first wakeup signal while performing the wakeup operation,
the second level bus block includes a second level PMU configured to generate a second wakeup signal while performing the wakeup operation in response to the first wakeup signal, and
the first level bus block includes a first level PMU configured to perform the wakeup operation in response to the second wakeup signal.

15. The semiconductor system of claim 14, further comprising:
a plurality of sub intellectual property (IP) blocks; and
an address decoder configured to generate an address wakeup signal based on address information of each of the plurality of sub IP blocks,
wherein the third level PMU includes a hierarchical register configured to mask the first wakeup signal in response to the address wakeup signal.

16. The semiconductor system of claim 13, further comprising:
a first level master intellectual property (IP) block configured to perform data communication with the first level bus block;
a plurality of sub IP blocks; and
an address decoder configured to generate an address wakeup signal based on address information of a specific sub IP block among the plurality of sub IP blocks,
wherein the first level bus block is configured to perform the wakeup operation in response to the wakeup signal generated by the first level master IP block or the address wakeup signal, and
the specific sub IP block is configured to perform the wakeup operation in response to the address wakeup signal.

17. The semiconductor system of claim 13, further comprising:
a first level master IP block configured to generate a fourth wakeup signal and perform data communication with the first level bus block; and
a first level sub IP block configured to perform data communication with the first level bus block,
wherein the first level bus block is configured to perform the wakeup operation in response to the fourth wakeup signal, and
the first level master IP block includes an interrupt request (IRQ) generator configured to transmit a fifth wakeup signal to the first level sub IP block before generating the fourth wakeup signal.

18. The semiconductor system of claim 17, further comprising: a system controller configured to perform a locking setting operation or an unlocking operation on the first level sub IP block,
wherein the IRQ generator is configured to transmit a control signal to the first level sub IP block and control the locking setting operation or the unlocking operation in response to the control signal.

19. An operating method of a semiconductor system comprising bus blocks and a plurality of intellectual property (IP) blocks, the operating method comprising:
transmitting a first wakeup signal to a second bus block that performs data communication with a first bus block among the bus blocks, while performing a wakeup operation on the first bus block;
transmitting a second wakeup signal to a third bus block that performs data communication with the second bus block, while performing the wakeup operation on the second bus block in response to the first wakeup signal; and
performing the wakeup operation on the third bus block in response to the second wakeup signal,
wherein the second bus block is a bus block of a higher level than the first bus block, and
the third bus block is a bus block of a higher level than the second bus block.

20. The operating method of claim 19, wherein the transmitting of the first wakeup signal includes masking the first wakeup signal when the wakeup operation on a first IP block that performs data communication with the first bus block among the plurality of IP blocks is performed.
